(19) United States
(12) Patent Application Publication
(10) Pub. No.: US 2007/0274602 A1
(43) Pub. Date: Nov. 29, 2007

(54) Image processor and image processing method

(75) Inventor: Norio Iriyama, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/714,149

(22) Filed: Mar. 6, 2007

(30) Foreign Application Priority Data
May 23, 2006 (JP) 2006-143104

(51) Int. Cl. G06K 9/36

(52) U.S. Cl. 382/252

(57) ABSTRACT

Disclosed is an image processor to perform error diffusion processing to an input image of m values pixel by pixel so as to convert to n values, n being smaller than m, including: a correction section to refer to a constant area which has been converted to n values before the error diffusion processing is performed to a target pixel to be an object of the error diffusion processing, and to correct a m-valued pixel value of the target pixel based on n-valued pixel values of the pixels constituting the constant area.

### BACKGROUND

1. Field of the Invention

The present invention relates to an image processor and an image processing method to perform error diffusion processing to an input image.

2. Description of Related Art

A printer or the like of electrophotography sometimes cannot output an isolated dot stably due to output characteristics of the printer. Meanwhile, in a printer of an ink-jet method, a dot output for each pixel does not always have a predetermined size corresponding to one pixel but the size changes larger or smaller. The change to be larger than a predetermined size is referred to as dot gain, and the change to be smaller is referred to as dot loss.

A method to correct these changes due to dot gain and dot loss during binarization of error diffusion has been disclosed (e.g. see JP 07-336543A and JP 08-9155A). According to this method, an amount of dot gain or dot loss occurred on a target pixel is obtained from a relation to the peripheral pixel thereof, so as to correct an error which propagates from the target pixel to an untreated pixel according to the obtained amount. Thus, a binarization can be performed in consideration of density change due to dot gain and dot loss.

In the method disclosed in the above-described JP 07-336543A and JP 08-9155A, four binarized pixels around a target pixel are referred to at binarization of the target pixel so that the propagating error is corrected. However, peripheral adjacent eight pixels affect the most regarding dot gain and dot loss occurred at the target pixel. Accordingly, it cannot be said that the above-described method achieves a sufficient correction because affect of dot gain or dot loss by the remaining peripheral five pixels is not incorporated.

### SUMMARY

It is an object of the present invention to enable a correction to reduce deterioration of image quality due to dot gain and dot loss.

In order to attain the above object, according to a first aspect of the invention, an image processor to perform error diffusion processing to an input image of m values pixel by pixel so as to convert to n values, n being smaller than m, comprises: a correction section to refer to a constant area which has been converted to n values before the error diffusion processing is performed to a target pixel to be an object of the error diffusion processing, and to correct a m-valued pixel value of the target pixel based on n-valued pixel values of the pixels constituting the constant area.

According to a second aspect of the invention, an image processing method to perform error diffusion processing to an input image of m values pixel by pixel so as to convert to n values, n being smaller than m, comprising the steps of: referring to a constant area which has been converted to n values before the error diffusion processing is performed to a target pixel to be an object of the error diffusion processing, and correcting a m-valued pixel value of the target pixel based on n-valued pixel values of the pixels constituting the constant area; and performing error diffusion processing to the corrected m-valued pixel value of the target pixel to convert to be an n-valued pixel.

### BRIEF DESCRIPTION OF THE DRAWINGS

The present invention will become fully understood by the following detailed description and the appended drawings, however, these are not intended to limit the scope of the invention, and wherein

FIG. 1 shows a structure of an image processor of the present embodiment;

FIG. 2 shows an example of a diffusion coefficient pattern;

FIG. 3 shows a target pixel and a predetermined area which is referred to in correction;

FIG. 4 shows an example of a correction table for dot gain correction; and

FIG. 5 shows an example of a correction table for dot loss correction.

### DETAILED DESCRIPTION OF THE PREFERRED EMBODIMENT

Hereinafter, an embodiment of an image processor and image processing method of the invention is described with reference to the drawings.

First, a structure is described.

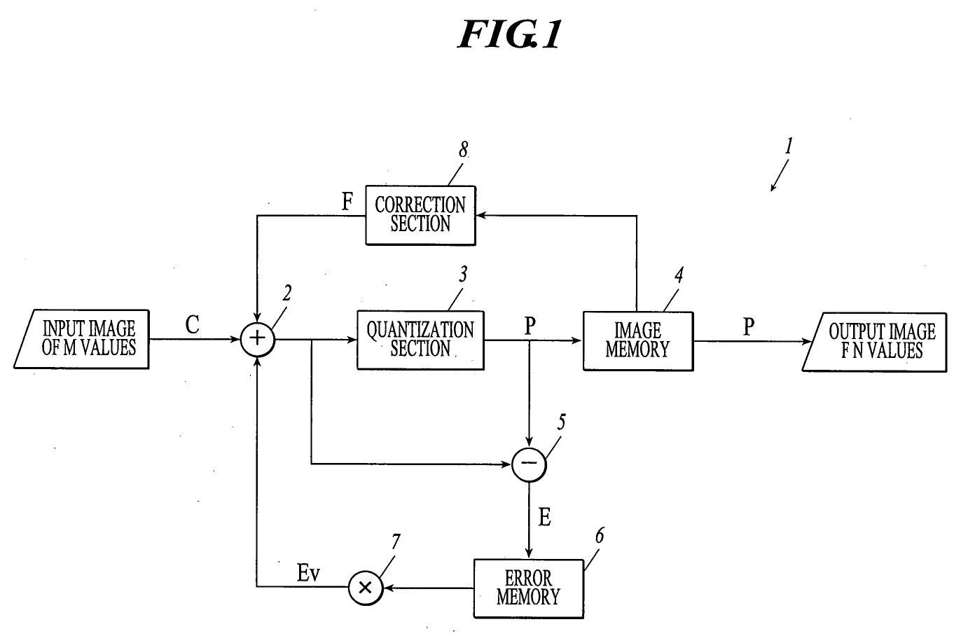

FIG. 1 shows a structure of an image processor 1 of the present embodiment.

The image processor 1 is to perform error diffusion processing to an input image of m values to form an output image of n values (n<m). The present embodiment describes an example where 1-bit, i.e. binary, output image is formed from an 8-bit, i.e. 256-value, input image.

The image processor 1 comprises, as shown in FIG. 1, an add section 2, a quantization section 3, an image memory 4, a subtract section 5, an error memory 6, a multiplex section 7, and a correction section 8.

The image processor 1 performs error diffusion processing to each pixel. Hereinafter, a pixel to be an object of the error diffusion processing is denoted as a target pixel XC to describe a function of each section.

The add section 2 is to add an error diffusion value Ev input from the multiplex section 7 and a correction value F input from the correction section 8 to a pixel value C (256-value) of the target pixel XC. The pixel value C to which the error diffusion value Ev and correction value F have been added is output to quantization section 3 and subtract section 5.

The quantization section 3 binarizes the pixel value C (256-value) using a threshold value TH. That is, where a pixel value after binarization is denoted as P, P is P=0 if C<TH, and P is P=1 if C≧TH. The pixel value P is output to the image memory 4 and subtract section 5.

The image memory 4 is composed of, for example, a line buffer and the like, and is to output the pixel value P input from the quantization section 3 to the correction section 8 after retaining the pixel value P temporarily. Further, the image memory 4 outputs the pixel value P externally as an output image.

The subtract section 5 subtracts the pixel value P (2-value) input from the quantization section 3 from the pixel value C (256-value) input from the add section 2, so as to calculate the difference therebetween. The calculated difference is output to the error memory 6 as an error value E.

The error memory 6 retains the error value E input from the subtract section 5 temporarily, and output it to the multiplex section 7.

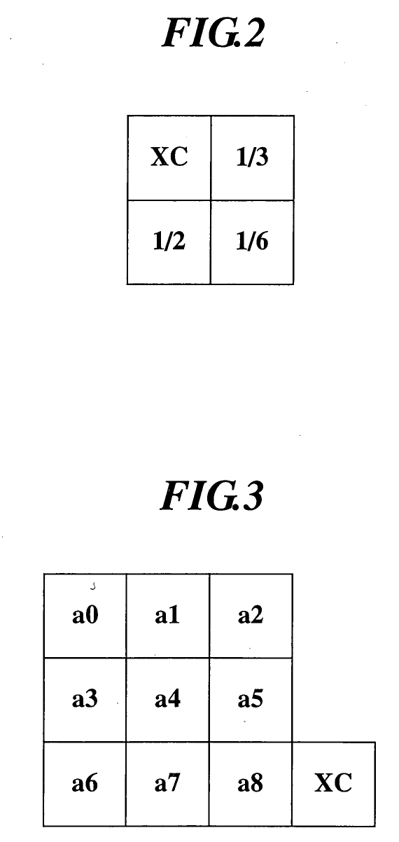

The multiplex section 7 is to calculate the error diffusion value Ev corresponding to each of a plurality of pixels to which error diffusion processing have not been performed (hereinafter referred to as diffusion object pixels) in order to diffuse error value E to the diffusion object pixels. The multiplex section 7 holds a diffusion coefficient pattern where a diffusion coefficient is previously defined corresponding to a position of each diffusion object pixel, as shown in FIG. 2. The diffusion coefficient pattern shown in FIG. 2 is to define diffusion coefficients for pixels located at the downside, right and lower right of the target pixel XC among the adjacent pixels thereof as ⅓, ½ and ⅙ respectively.

The multiplex section 7 obtains diffusion coefficients from this diffusion coefficient pattern, and multiplexes them with the input error value E. In the example of the diffusion coefficient pattern shown in FIG. 2, the error diffusion values Ev for the diffusion object pixels at the right, downside and lower right of the target pixel XC becomes ⅓E, ½E and ⅙E respectively. The error diffusion values Ev corresponding to diffusion object pixels are output to the add section 2. A delay section (not shown) is provided between the multiplex section 7 and add section 2, and the error diffusion value Ev is output to the add section 2 at a time corresponding to the diffusion object pixel being input to the add section 2 as the target pixel XC.

An error diffusion processing is a series of the above-described processing. That is, an error generated by the binarization of a pixel is diffused to unprocessed pixels located around the binarized pixel so that a halftone can be reproduced finely.

The correction section 8 corrects a pixel value (255-value) of the target pixel XC prior to the error diffusion processing of the target pixel XC. This correction is to correct a density change on the target pixel XC due to dot gain or dot loss which is estimated to occur at a certain area as a result of the error diffusion processing.

Hereinafter, a correction method is described.

The correction section 8 refers to a pixel value of a constant area which is adjacent to the target pixel XC and has already been binarized by the error diffusion processing.

FIG. 3 shows the target pixel XC and constant area. As shown in FIG. 3, the constant area is composed of 3×3 pixels of pixels a0 to a8. The correction section 8 calculates a correction value F of the target pixel XC based on the pixel values (binary) of pixels a0 to a8.

The correction section 8 has a correction table in which the correction values F to eliminate the density change due to dot gain or dot loss are previously defined corresponding to a relation between the pixel values (binary) of pixels a0 to a8

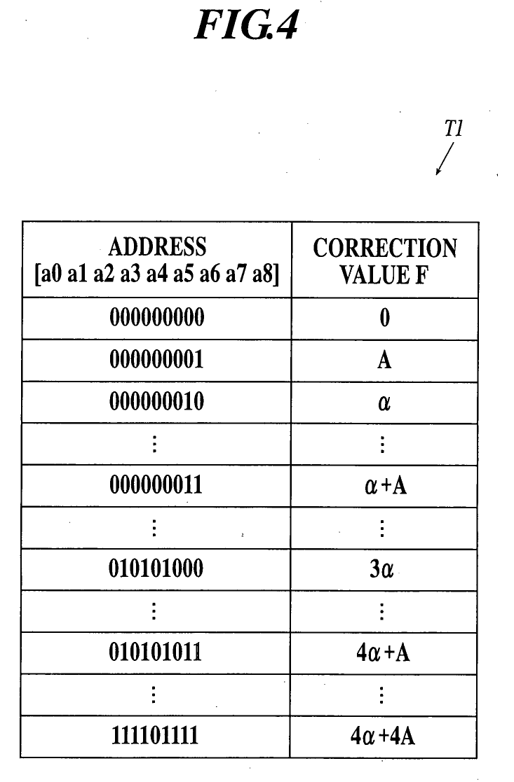

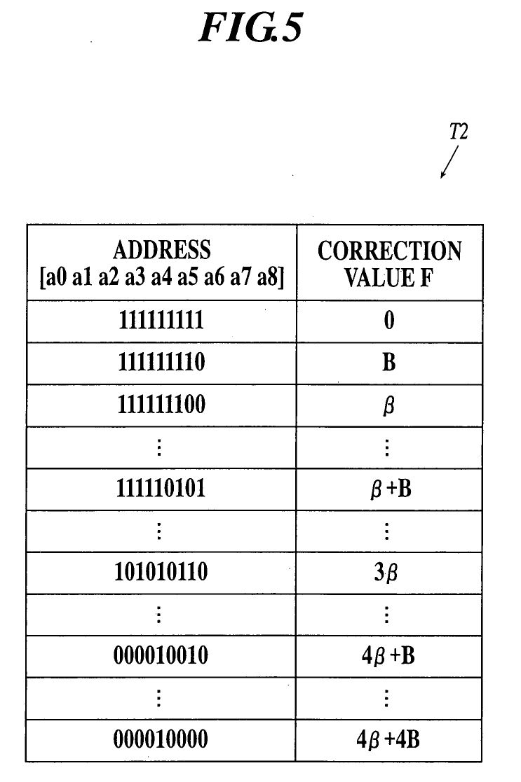

FIGS. 4 and 5 show an example of the correction table. FIG. 4 shows an example of a correction table T1 for correcting dot gain, and FIG. 5 shows an example of a correction table T2 for correcting dot loss. These correction tables T1 and T2 store correction values F corresponding to an address which is an alignment [a0 a1 a2 a3 a4 a5 a6 a7 a8] of pixel values (binary) of peripheral pixels a0 to a8.

The correction values F are previously calculated values necessary to eliminate estimated density change due to dot gain or dot loss generated according to a combination of the pixel values (binary) of pixels a0 to a8. The correction values F are calculated by the following procedure.

Dot gain occurs when a center pixel a4 in the constant area has a pixel value (binary) of “0”. Accordingly, in the correction table T1 for correcting dot gain, the correction values F are set associated with addresses which are combinations of the pixel value “0” of pixel a4 and pixel values (binary) of the other pixels a1 to a3 and a5 to a8. Since a pixel value of the target pixel is reduced in order to correct excess density due to dot gain, the correction values are set to negative values.

Assumed that a pixel value to offset an excess density generated at pixel a4 is α (α<0) when pixels a1, a3, a5 and a7 adjacent at the left, right, downside, upside of pixel a4 simply have pixel values of “1”, and that a pixel value to offset an excess density generated at pixel a4 is A (A<0) when pixels a0, a2, a4 and a6 located diagonally around pixel a4 have pixel values of “1”, the correction value F can be obtained from the following formula (1).

F=(a1+a3+a5+a7)×α+(a0+a2+a6+a8)×A. (1)

For example, when pixels a0, a2, a4 and a6 have the pixel values of “0” and pixels a1,a3, a5 and a7 have the pixel values of “1”, the correction value F=4α+A is obtained from the above formula (1).

On the contrary, dot loss occurs only when the center pixel a4 has a pixel value of “1”. Accordingly, in the correction table T1 for correcting dot loss, the correction values F are set associated with addresses which are combinations of the pixel value a4=1 and pixel values (binary) of the other pixels a0 to a3 and a5 to a8. Since a pixel value of the target pixel is increased in order to correct density shortage due to dot loss, the correction value is set to a positive value.

Assumed that a pixel value to offset a density shortage generated at pixel a4 is β (β<0) when pixels al, a3, a5 and a7 adjacent at the left, right, downside, upside of pixel a4 simply have pixel values of “0”, and that a pixel value to offset a density shortage generated at pixel a4 is B (B<0) when pixels a0, a2, a4 and a6 located diagonally around pixel a4 have pixel values of “0”, the correction value F can be obtained from the following formula (2).

F={4−(a1+a3+a5+a7)}×β+{4−(a0+a2+a6+a8)×βB} (2)

The correction section 8 acquires the pixel values (binary) of the peripheral pixels a0 to a8 of the target pixel XC from the image memory 4. Thereafter, the correction section 8 acquires the correction value F corresponding to the alignment of the pixel values (binary) of pixels a0 to a8 from the correction table T1 or T2, and outputs it to the add section 2. The add section 2 is to add the correction value F to a pixel value C of the target pixel XC. Thus, error diffusion processing for the target pixel XC is performed using the corrected pixel value C.

That is, the correction section 8 can correct density change generated on pixel a4 as a result of error diffusion processing, at the target pixel XC.

For example, when a combination of pixels a0 to a8 is [a0 a1 a2 a3 a4 a5 a6 a7 a8]=[000010000], the correction value F=4β+4 is obtained from the correction table T2 and added to the pixel value C of the target pixel XC. On the target pixel XC, error diffusion processing is performed to a pixel value which increases by 4β+4 from the original pixel value C. In this case, a binary pixel value P of the target pixel XC becomes more liable to be 1. As above, the correction on the correction section 8 is to correct a density shortage of pixel a4 at the target pixel XC by increasing the pixel value of the target pixel XC by 4β+4 so as to increase an output density of the target pixel XC.

As described above, according to the embodiment of the present invention, dot gain or dot loss generated in the constant area composed of pixels a0 to a8 is estimated, and a pixel value corresponding to an excess amount of density due to the dot gain is subtracted from the pixel value C of the target pixel XC, or a pixel value corresponding to a shortage amount of density due to the dot loss is added to the pixel value C of the target pixel XC. As a result, a density change locally generated by error diffusion processing can be offset as a whole image, so that image deterioration due to dot gain or dot loss can be reduced.

Furthermore, the peripheral pixels a0 to a8 greatly affect whether dot gain or dot loss occurs at pixel a4 and, if it occurs, how much the density changes by the dot gain or dot loss. In the present embodiment, the correction value P is determined according to the pixel values (binary) of all pixels a0 to a8 in the area of 3×3 pixels square. Furthermore, the correction value F is a pixel value set in the correction table T1 and T2, which is obtained by estimating an amount of density change generated on pixel a4 based on a combination of the pixel values (binary) of pixels a0 to a8 and calculating it as a pixel value required to correct the density change. Thus, density change can be estimated more precisely so that correction accuracy can be improved.

The above description is one of preferred embodiments to which the present invention is applied, and the present invention is not limited thereto.

The above embodiment is an example where an input image is binarized. The correction-can be performed similarly when input image is converted to n (2 or more) values such as 3, 4 and 5 values. In such case, a correction table is drawn according to the possible combinations of pixels a0 to a8.

Furthermore, in the above description, correction value F is determined by referring to the area of pixels a0 to a8 which is adjacent to the target pixel XC. The area to be referred may not be adjacent to the target pixel XC. However, in consideration of an image quality, it is preferable that a localized density change is corrected in the peripheral area having similar density. Thus, it is preferable to refer a constant area located at vicinity of the target pixel XC.

Furthermore, in the embodiment, the correction value F is calculated by quantizing an amount of density change based on whether the pixels are located on vertical and horizontal positions or on diagonal positions. However, the calculation is not limited thereto.

For example, there is a case where print timing differs between a main scanning direction and sub scanning direction due to characteristics of an output means such as a printer. Accordingly, the pixel values α and β required for the correction may be set in more detail whether the position is upside and downside (main scanning direction) or right and left (sub scanning direction), so that the correction value F is determined such that upside and downside pixels al and a7 correspond to α1 and β1 and right and left pixels a3 and a5 correspond to α2 and β2.

In this case, the correction value F is calculated from the following formulae (3) and (4). Formula (3) is the correction value F for correcting dot gain and formula (4) is the correction value F for correcting dot loss.

F=(a1+a7)×α1+(a3+a5)×α2+(a0+a2+a6+a8) (3)

F=(2−a1+a7)×β1+(2−a3+a5)×β2+(4−a0+a2+a6+a8)×B (4)

This correction value F enables to perform more accurate correction according to an actual output condition.

Alternatively, dot gain or dot loss actually having been generated in the nine pixels may be measured to set the corresponding correction value. For example, a plurality of test patterns where combinations of pixel values (binary) of pixels a0 to a8 vary are drawn and output by a printer, and each amount of density change due to dot gain or dot loss is measured. Thereafter, the correction values F according to the measured values are set on a correction table. In this case, it becomes possible to perform a correction according to output characteristics of a printer to be used actually, and correction accuracy is improved.

The present U.S. patent application claims a priority under the Paris Convention of Japanese patent application No. 2006-143104 filed on May 23, 2006, which shall be a basis of correction of an incorrect translation.

What is claimed is:

1. An image processor to perform error diffusion processing to an input image of m values pixel by pixel so as to convert to n values, n being smaller than m, comprising:
a correction section to refer to a constant area which has been converted to n values before the error diffusion processing is performed to a target pixel to be an object of the error diffusion processing, and to correct a m-valued pixel value of the target pixel based on n-valued pixel values of the pixels constituting the constant area.

2. The image processor of claim 1, wherein the correction section corrects the m-valued pixel value of the target pixel according to a combination of the n-valued pixel values of the pixels constituting the contact area.

3. The image processor of claim 1, wherein the correction section comprises a correction table where correction values are associated with the combinations of the n-valued pixel value of the pixels constituting the constant area, and corrects the m-valued pixel value of the target pixel based on the correction value obtained with the correction table.

4. The image processor of claim 3, wherein the correction values are calculated by previously estimating an amount of density change due to dot gain or dot loss.

5. The image processor of claim 3, wherein the correction values are set by measuring an output test pattern by printing.

6. The image processor of claim 1, wherein the constant area is a 3×3 pixels square located around the target pixel.

7. An image processing method to perform error diffusion processing to an input image of m values pixel by pixel so as to convert to n values, n being smaller than m, comprising the steps of:
referring to a constant area which has been converted to n values before the error diffusion processing is performed to a target pixel to be an object of the error diffusion processing, and correcting a m-valued pixel value of the target pixel based on n-valued pixel values of the pixels constituting the constant area; and
performing error diffusion processing to the corrected m-valued pixel value of the target pixel to convert to be an n-valued pixel.

8. The image processing method of claim 7, wherein in the correction step, the m-valued pixel value of the target pixel is corrected according to a combination of the n-valued pixel values of the pixels constituting the contact area.

9. The image processing method of claim 8, wherein in the correcting step, the m-valued pixel value of the target pixel is corrected using a correction table where the combinations of the n-valued pixel value of the pixels constituting the constant area are associated with correction values.

10. The image processor of claim 9, wherein the correction values are calculated by previously estimating an amount of density change due to dot gain or dot loss.

11. The image processor of claim 9, wherein the correction values are set by measuring an output test pattern by printing.

12. The image processor of claim 7, wherein the constant area is a 3×3 pixels square located around the target pixel.
